(19) United States
(12) Patent Application Publication
(10) Pub. No.: US 2014/0254754 A1
(43) Pub. Date: Sep. 11, 2014

(54) RADIATION GENERATING APPARATUS AND RADIATION IMAGING SYSTEM

(71) Applicant: CANON KABUSHIKI KAISHA, Tokyo (JP)

(72) Inventors: Yoichi Ikarashi, Fujisawa-shi (JP); Takeo Tsukamoto, Kawasaki-shi (JP); Yasuo Ohashi, Kawasaki-shi (JP)

(73) Assignee: CANON KABUSHIKI KAISHA, Tokyo (JP)

(21) Appl. No.: 14/192,275

(22) Filed: Feb. 27, 2014

(30) Foreign Application Priority Data
Mar. 5, 2013 (JP) 2013-042743

(51) Int. Cl. G21K 1/04; G01N 23/04

(52) U.S. Cl. CPC G21K 1/04; G01N 23/04
USPC 378/62; 378/150

(57) ABSTRACT

A radiation generating apparatus including: a radiation generating unit for emitting radiation through a transmission window; and a movable diaphragm unit including a restricting blade for adjusting a size of a radiation field and a light projecting and collimating device for making simulation display of the radiation field with a visible light field, in which the light projecting and collimating device includes a light source for emitting visible light, and a reflection plate disposed obliquely to a radiation center axis, the reflection plate having a reflection surface for reflecting the visible light and transmitting the radiation; the visible light field is formed of the visible light which is emitted from the light source and is reflected by the reflection plate; and a compensating member having a thickness variation for reducing unevenness of the radiation emitted in the radiation field is disposed on a radiation exit side of the reflection plate.

### BACKGROUND OF THE INVENTION

1. Field of the Invention

The present invention relates to a radiation generating apparatus used for diagnostic application or nondestructive X-ray imaging in a medical equipment field or an industrial equipment field, and to a radiation imaging system using the radiation generating apparatus.

2. Description of the Related Art

A typical radiation generating apparatus includes a radiation generating unit including a radiation tube and a movable diaphragm unit provided on a front surface of a transmission window of the radiation generating unit. The movable diaphragm unit has a radiation field adjustment function for shielding, out of radiation emitted through the transmission window of the radiation generating unit, a part of the radiation unnecessary for imaging so as to reduce exposure of a subject. In addition, this movable diaphragm unit has an additional function for checking a radiation field range by a naked eye before taking an image by making simulation display of the radiation field with a visible light field.

A typical movable diaphragm unit includes a reflection plate for transmitting radiation and reflecting visible light, a restricting blade for defining the radiation field and the visible light field formed in accordance with the radiation field, and a light source.

Japanese Patent Application Laid-Open No. 2005-6971 discloses a movable diaphragm unit including a movable reflection plate (reflection mirror) that is retracted when emitting radiation, so as to prevent a decrease of radiation amount caused when the radiation passes through the reflection plate.

With reference to FIG. 5, a related-art movable diaphragm unit is described. Radiation emitted from a radiation tube is emitted through an opening 8 into a movable diaphragm unit 122. The radiation after passing through a reflection plate 4 is determined to have a radiation field 6 by an opening 5 of a restricting blade 2 and is emitted to the outside through a transparent plate 7. The reflection plate 4 reflects visible light from a light source 3 by a reflection surface 4a, and simulation display of the radiation field 6 is made with the visible light field.

The reflection plate 4 includes the reflection surface 4a for reflecting the visible light and has a uniform thickness t, and the normal to the reflection surface 4a is inclined from a radiation center axis 11 by an angle φ. Here, the radiation center axis 11 means a straight line connecting a focal point 10 of the radiation and the center of the radiation field 6 when the restricting blade 2 is opened at most.

Here, because the reflection plate 4 is disposed obliquely to the radiation center axis 11, a transmission angle for the radiation to pass through the reflection plate is different depending on a radiation direction. This difference of the transmission angle varies the quality and amount of the transmitted radiation so that the radiation cannot be emitted with uniform intensity. The variations of quality and amount of the radiation caused when passing through the reflection plate 4 are referred to as a filter effect of the reflection plate 4.

It is known that a reflection type radiation tube varies the quality and amount of the radiation due to a heel effect depending on a radiation position. A method of relieving the variations involves adjusting a mounting direction of the reflection plate 4 so that the filter effect of the reflection plate 4 and the heel effect can be canceled out by each other.

However, because a transmission type radiation tube does not cause the heel effect, if the reflection plate is disposed obliquely, there is a problem in that the filter effect promotes the variations of quality and amount of the radiation (shading).

A transmission length for the radiation emitted from the focal point 10 to pass through the radiation center axis 11 is t/sin φ when the radiation passes through the reflection plate 4. In contrast, transmission lengths for radiations 11a and 11b emitted from the focal point 10 at an angle θ with respect to the radiation center axis 11 are different when the radiations pass through the reflection plate 4 depending on a positional relationship of the reflection plate 4. The transmission length for the radiation 11a to pass through a part close to the focal point 10 is t/sin(φ+θ), and the transmission length for the radiation 11b to pass through a part distant from the focal point 10 is t/sin(φ−θ). Therefore, a difference between the transmission lengths for the radiation 11a and the radiation 11b to pass through the reflection plate 4 is t(1/sin(φ−θ)−1/sin(φ+θ)).

In this way, the filter effect of the reflection plate 4 is caused by the difference of the transmission length for the radiation to pass through the inside of the reflection plate 4 depending on the radiation direction, because the normal to the reflection plate 4 is disposed obliquely to the radiation center axis 11.

Further, even in the reflection type radiation generating apparatus having the heel effect, there is a problem in that the shading due to the heel effect cannot be sufficiently reduced depending on an arrangement angle of the reflection plate 4.

Here, these problems can be solved if the reflection plate 4 is movable to be retracted from the radiation field 6 when the radiation is emitted. However, it is necessary to dispose an additional mechanism for retracting the reflection plate 4. Therefore, there is a problem in that the structure becomes complicated, and the entire apparatus becomes larger.

### SUMMARY OF THE INVENTION

The present invention is made in view of the above-mentioned related-art problems, and an object thereof is to provide a radiation generating apparatus having reduced shading without increasing a size of the entire apparatus.

In order to solve the above-mentioned problems, according to one embodiment of the present invention, there is provided a radiation generating apparatus including: a radiation generating unit for emitting radiation through a transmission window; and a movable diaphragm unit including a restricting blade for adjusting a size of a radiation field and a light projecting and collimating device for making simulation display of the radiation field with a visible light field, in which: the light projecting and collimating device includes a light source for emitting visible light, and a reflection plate disposed obliquely to a radiation center axis, the reflection plate having a reflection surface for reflecting the visible light while transmitting the radiation; the visible light field is formed of the visible light which is emitted from the light source and is reflected by the reflection plate; and the movable diaphragm unit further includes, on a radiation exit side of the reflection plate, a compensating member having a thickness variation for reducing unevenness of the radiation emitted in the radiation field.

Further features of the present invention will become apparent from the following description of exemplary embodiments with reference to the attached drawings.

### BRIEF DESCRIPTION OF THE DRAWINGS

FIG. 1 is a cross-sectional view schematically illustrating a radiation generating apparatus according to a first embodiment of the present invention.

FIG. 2 is a cross-sectional view schematically illustrating a movable diaphragm unit according to the first embodiment.

FIG. 3 is a cross-sectional view schematically illustrating a movable diaphragm unit according to a second embodiment of the present invention.

FIG. 4 is a block diagram schematically illustrating a radiation imaging system according to a third embodiment of the present invention.

FIG. 5 is a cross-sectional view schematically illustrating a related-art movable diaphragm unit.

### DESCRIPTION OF THE EMBODIMENTS

Now, exemplary embodiments of the present invention are described in detail with reference to the drawings. As radiation in the present invention, an X-ray is preferably used, but a neutron beam or a proton beam may also be used.

### First Embodiment

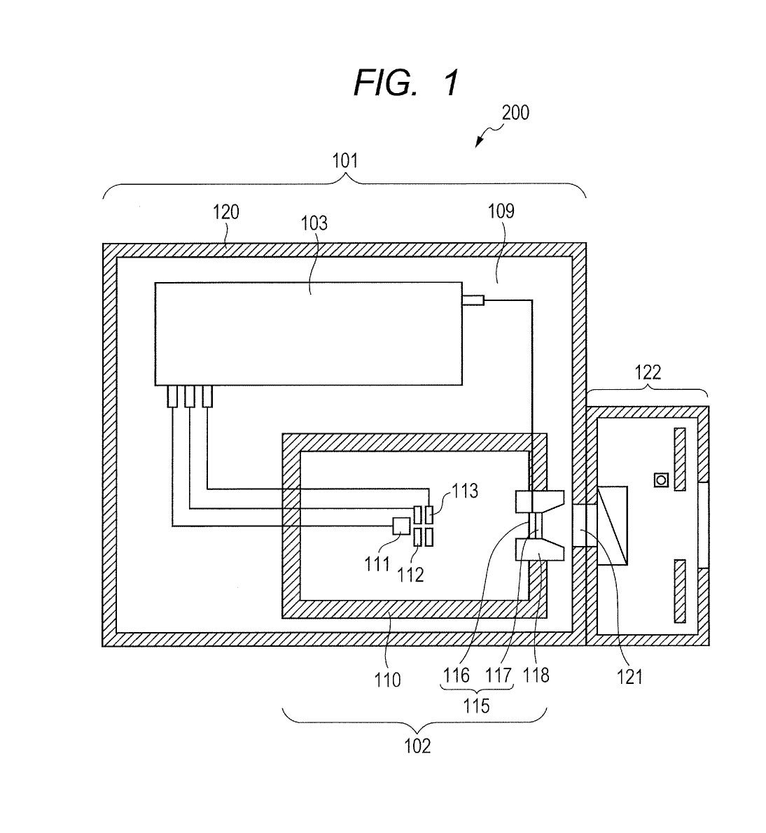

FIG. 1 illustrates a radiation generating apparatus of this embodiment, and FIG. 2 illustrates a movable diaphragm unit of the radiation generating apparatus. A radiation generating apparatus 200 is equipped with a radiation generating unit 101 and a movable diaphragm unit 122.

<Radiation Generating Unit>

The radiation generating unit 101 emits radiation through a transmission window 121. In a housing 120 including the transmission window 121, there are disposed a radiation tube 102 as a generation source of the radiation, and a drive circuit 103 for driving and controlling the radiation tube 102. The free space in the housing 120 is filled with insulating liquid 109.

It is desired that the housing 120 be strong enough as a container and be excellent in heat dissipation. Exemplary suitable materials used for forming the housing 120 include a metal material such as brass, iron, and stainless steel.

The insulating liquid 109 has electric insulation, and has a role of maintaining electric insulation inside the housing 120 and a role as a cooling medium for the radiation tube 102. As the insulating liquid 109, it is preferred to use electric insulating oil such as mineral oil and silicone oil.

The radiation tube 102 is a transmission type radiation tube, which generates radiation by accelerating electrons with a high voltage so as to collide with a target 115. Then, the radiation emitted from a surface of the target 115 opposite to a surface irradiated with the electrons is extracted to the outside. In addition, the radiation tube 102 includes a shield member 118 for regulating the direction of the radiation emitted to the outside.

The shield member 118 blocks unnecessary radiation and is made of lead or tungsten.

The target 115 is formed by providing a target layer 116 for generating radiation through electron irradiation on a support substrate 117 which satisfactorily transmits radiation, and is mounted under a state in which the target layer 116 is provided on the inner side. As the target layer 116, for example, tungsten, tantalum, or molybdenum is used. The target layer 116 is electrically connected to the drive circuit 103 and forms part of an anode.

A barrel of a vacuum container 110 is formed of an insulating tube of an insulating material such as glass and ceramic so as to maintain a vacuum of the inside thereof and to electrically insulate between a cathode 111 and the anode including the target layer 116.

It is preferred that the vacuum inside the vacuum container 110 be about 10⁻⁴ Pa to 10⁻⁸ Pa.

The cathode 111 is provided so as to be opposed to the target layer 116 of the target 115. As the cathode 111, a hot cathode such as a tungsten filament and an impregnated cathode, or a cold cathode such as a carbon nanotube can be used.

The cathode 111, a grid electrode 112, and a lens electrode 113 that constitute the electron source are electrically connected to the drive circuit 103, and predetermined voltages are applied thereto. An acceleration voltage Va applied between the cathode 111 and the target layer 116 depends on the use of the radiation, but generally is about 10 kV to 150 kV.

Electrons that are derived from the cathode 111 by an electric field formed by the grid element 112 are converged by the lens electrode 113 and enter the target layer 116 of the target 115, to thereby generate radiation from the target layer 116. The generated radiation passes through the support substrate 117 of the target 115, and further, through the transmission window 121, the radiation is emitted to the movable diaphragm unit 122.

<Movable Diaphragm Unit>

The movable diaphragm unit 122 includes an envelope 1, a restricting blade 2 disposed in the envelope 1, and a light projecting and collimating device. The light projecting and collimating device includes a light source 3 and a reflection plate 4.

The envelope 1 is disposed to enclose an outer periphery of the transmission window 121 of the housing 120. In addition, on a side of the envelope 1 opposite to an opening 8 provided therein so as to correspond to the transmission window 121, there is provided an opening for transmitting the radiation emitted from the radiation generating unit 102. A transparent plate 7 is disposed in the opening.

The envelope 1 is preferably made of a material having a radiation shielding effect so as to block scattering radiation. As this material, it is possible to use a metal such as lead, tungsten and tantalum, and an alloy of these metals. In addition, it is possible to provide the radiation shielding effect by using a metal such as aluminum and a synthetic resin not having so high radiation shielding effect to form the envelope 1 and bonding a sheet having a high radiation shielding effect thereto. An example of this sheet includes a resin sheet containing tungsten powder.

The restricting blade 2 is made of a radiation shielding material, and the middle part thereof is provided with an opening 5 for permitting the radiation and the visible light to pass through. The radiation emitted from the radiation generating unit 101 is emitted to the outside in a radiation range restricted by the opening 5 so as to form a radiation field 6. A size of the opening 5 can be adjusted, so as to adjust a size of the radiation field 6.

The restricting blade 2 can, for example, include two plate members having a notch or a hole which are overlapped with each other in a slidable manner so that the notches or the holes are overlapped with each other. In this case, the opening 5 is formed as an overlapped part of the notches or the holes, and the size of the opening 5 can be adjusted by sliding the two plate members relatively to each other. In addition, it is possible to use a structure in which multiple plate members are overlapped with each other in a slidable manner at shifted positions so that the opening 5 to be formed is surrounded by the plate members, or to use a structure similar to a shutter of a camera.

The light source 3 emits the visible light and may be an incandescence lamp, a halogen lamp, a xenon lamp, a light emitting diode (LED), or the like, for example. In addition, the light source 3 is disposed at a position deviated from a path of the radiation emitted in the necessary radiation field so as not to interrupt with the radiation.

The reflection plate 4 is configured to reflect the visible light emitted from the light source 3 so as to make simulation display of the radiation field 6 as the visible light field, and is disposed obliquely in the path of the radiation between the transmission window 121 and the restricting blade 2. Therefore, the reflection plate 4 includes the reflection surface 4a that can transmit the radiation and reflect the visible light.

The reflection plate 4 and the light source 3 are disposed so that the radiation field 6 and the visible light field are matched with each other.

The reflection plate 4 includes the reflection surface 4a for the visible light on one side, and a compensating member 9 is disposed on the radiation emitting side of the reflection plate 4, namely the reflection surface 4a side. The reflection plate 4 and the compensating member 9 may be disposed separately or disposed in a combined manner so that the compensating member 9 is integrated with the reflection plate 4 via the reflection surface 4a as illustrated in FIG. 2.

The compensating member 9 has a thickness variation for reducing unevenness of the radiation emitted in the radiation field 6. Specifically, a shape of the compensating member 9 is selected so that the transmission length for the radiation to pass through the reflection plate 4 and the transmission length for the radiation to pass through the compensating member 9 compensate for each other. Therefore, it is preferred to set the thickness variation of the compensating member 9 so that the compensating member 9 is thicker on the side closer to a focal point 10 of the radiation and thinner on the side distant from the focal point 10. It is more preferred to adopt a structure in which the reflection plate 4 also has a thickness variation, and the thickness varies oppositely between the reflection plate 4 and the compensating member 9 so that a total thickness of the reflection plate 4 and the compensating member 9 is constant.

FIG. 2 illustrates an example in which the reflection plate 4 and the compensating member 9, which are formed in triangular prisms each having a cross section of a right triangle, are combined to be a rectangular parallelepiped. In this structure, the reflection plate 4 is positioned on the path of the radiation between the transmission window 121 and the restricting blade 2 in such a manner that an incidence surface of the reflection plate 4 for the radiation is perpendicular to a radiation center axis 11.

A size of the rectangular parallelepiped needs to be large enough for completely transmitting a necessary radiation emitted from the focal point 10, but it is desired to set the size as small as possible for reducing the transmission length as short as possible to prevent a decrease of radiation amount and for downsizing the movable diaphragm unit 122. For instance, it is preferred for the rectangular parallelepiped to have a side length of 5 mm to 50 mm.

In this case, a radiation 11a emitted in the direction of an angle θ with respect to the radiation center axis 11 has a long transmission length to pass through the reflection plate 4 and a short transmission length to pass through the compensating member 9. On the contrary, a radiation 11b emitted in the direction of an angle −θ with respect to the radiation center axis 11 has a short transmission length to pass through the reflection plate 4 and a long transmission length to pass through the compensating member 9. In this way, the transmission lengths for the radiation to pass through the reflection plate 4 and for the radiation to pass through the compensating member 9 compensate for each other so that the difference of the transmission length depending on the radiation direction can be reduced.

The reflection plate 4 can be formed by forming a reflecting material layer having good reflection characteristics for the visible light on the surface of a base transmitting the radiation. The base is preferably made of a material having high visible light transmissivity and high radiation transmissivity such as glass, polymethylmethacrylate resin (PMMA), and acrylic resin. In addition, the reflecting material layer is preferably made of a material having a metallic luster such as aluminum and silver.

The compensating member 9 is preferably made of the same material as the base of the reflection plate 4.

When the radiation generating apparatus 200 is used, the simulation display is usually made with the visible light field before emitting the radiation so that the radiation field 6 is checked by the naked eye. This checking is performed by permitting the light source 3 to emit light. The visible light emitted from the light source 3 is reflected by the reflection surface 4a of the reflection plate 4 and passes through the opening 5 of the restricting blade 2 so as to form the visible light field. In this state, the opening 5 of the restricting blade 2 is adjusted so that the radiation field 6 has a necessary size. After determining the size of the radiation field 6, the light source 3 is turned off, and the radiation generating unit 101 is driven.

The radiation emitted toward the movable diaphragm unit 122 passes through the reflection plate 4, passes through the opening 5 of the restricting blade 2, and is emitted in the predetermined radiation field 6. In this case, the transmission length for the radiation to pass through the reflection plate 4 on the radiation incident side of the reflection plate 4 is compensated by the transmission length for the radiation to pass through the compensating member 9 on the radiation exit side, and hence the difference of the transmission length depending on the radiation direction can be reduced. Therefore, in this embodiment, the shading due to the filter effect of the reflection plate 4 can be reduced to be smaller than hitherto.

### Second Embodiment

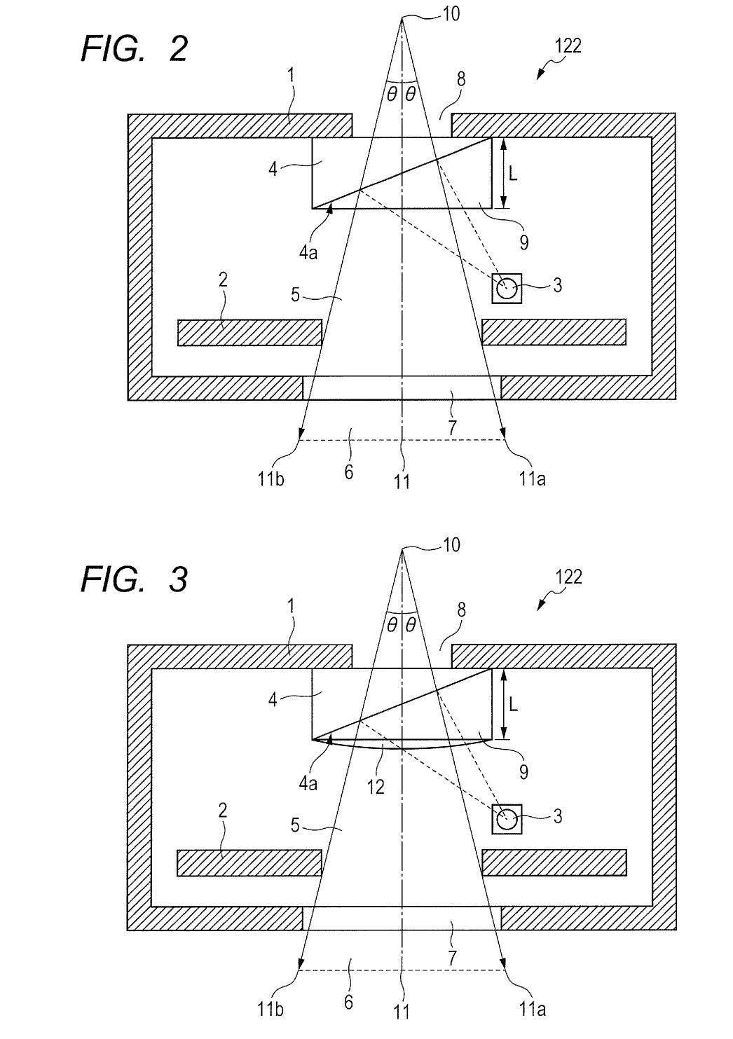

FIG. 3 illustrates a movable diaphragm unit 122 according to a second embodiment of the present invention.

This embodiment has a feature in that a convex lens 12 having a largest thickness at a part corresponding to the radiation center axis 11 is disposed on the radiation exit side of the compensating member 9, and other structures than the convex lens 12 are the same as those in the first embodiment.

The convex lens 12 has a shape such as to reduce the transmission length difference between the radiation passing along the radiation center axis 11 and the radiation 11a or 11b emitted from the focal point 10 with the angle θ or −θ with respect to the radiation center axis when passing through the reflection plate 4 and the compensating member 9.

When the length of the sides of the reflection plate 4 and the compensating member 9 parallel to the radiation center axis 11 is L, the transmission length for the radiation to pass through the reflection plate 4 and the compensating member 9 along the radiation center axis is L. In addition, the transmission length for the radiation 11a or 11b emitted from the focal point 10 with the angle θ or −θ with respect to the radiation center axis is L/cos θ. Therefore, the transmission length difference between the radiation along the radiation center axis 11 and the radiation 11a or 11b is L((1/cos θ)−1).

The convex lens 12 has a shape such as to correct the transmission length difference L((1/cos θ)−1). For instance, it is possible to use a convex lens having a diameter of 5 mm to 50 mm, a center thickness of 1 mm to 5 mm, and a radius of curvature of 30 mm to 150 mm.

The convex lens 12 is preferably made of a material having high visible light transmissivity and high radiation transmissivity such as glass, polymethylmethacrylate resin (PMMA), and acrylic resin.

The reflection plate 4, the compensating member 9, and the light source 3 are disposed considering visible light dispersion by the convex lens 12 so that the radiation field 6 and the visible light field are matched with each other.

According to this embodiment, the transmission length difference of the radiation passing through the reflection plate 4 and the compensating member 9 depending on the transmission direction can be reduced by the convex lens 12 to be smaller than that of the first embodiment.

### Third Embodiment

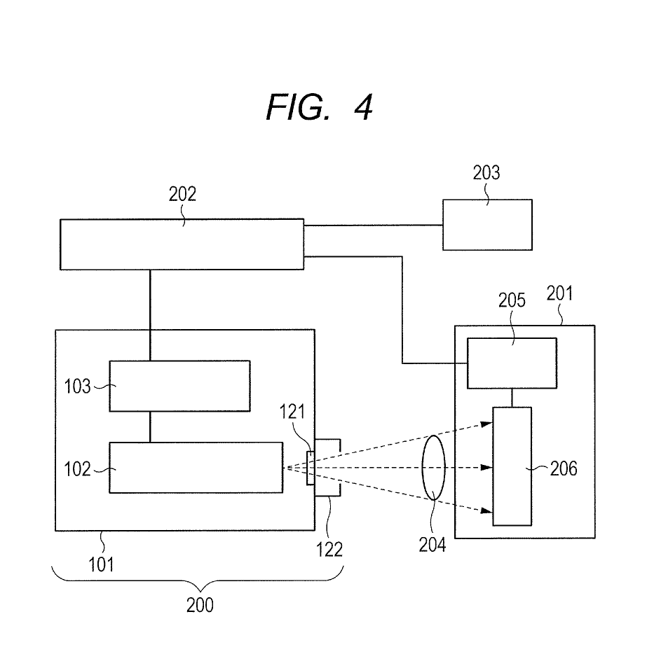

FIG. 4 is a structural diagram illustrating a radiation imaging system according to this embodiment. A system controlling apparatus 202 controls the radiation generating apparatus 200 similar to that described in the first embodiment or the second embodiment and a radiation detecting apparatus 201 in a coordinated manner. The drive circuit 103 outputs various control signals to the radiation tube 102 under control by the system controlling apparatus 202. With this control signal, an emission state of the radiation emitted from the radiation generating apparatus 200 is controlled. The radiation emitted from the radiation generating apparatus 200 passes through an analyte 204 and is detected by a detector 206. The detector 206 converts the detected radiation into an image signal and outputs the image signal to a signal processor 205. Under control by the system controlling apparatus 202, the signal processor 205 performs a predetermined signal processing on the image signal and outputs the processed image signal to the system controlling apparatus 202. The system controlling apparatus 202 outputs a display signal for controlling a display apparatus 203 to display an image to the display apparatus 203 based on the processed image signal. The display apparatus 203 displays the image based on the display signal as a taken image of the analyte 204 on a screen.

In the first embodiment and in the second embodiment, the transmission type radiation tube is described as an example of the radiation tube. However, the present invention can be applied to a case where a reflection type radiation tube is used. As described above, the transmission type radiation tube cannot obtain the effect of canceling out the heel effect with the filter effect of the reflection plate unlike the reflection type radiation tube. Therefore, the transmission type radiation tube can be used more appropriately in the present invention.

### EXAMPLE 1

The radiation generating apparatus having the structure illustrated in FIGS. 1 and 2 was manufactured.

Two right triangular prisms made of glass each having a cross section of a right triangle in which lengths of two sides forming the right angle of the triangle were 10 mm and 30 mm, and a height of 30 mm were prepared. One of the right triangular prisms was used as the reflection plate 4 with the oblique reflection surface 4a formed by vapor deposition of an aluminum film having a thickness of 10 μm. In addition, the other right triangular prism was used as the compensating member 9 with the oblique surface bonded to the reflection surface 4a to be integrated with the reflection plate 4.

The combined body of the reflection plate 4 and the compensating member 9 was disposed in the movable diaphragm unit 122 with the radiation incident surface of the reflection plate 4 being provided on the transmission window 121 side, so that the radiation center axis 11 was perpendicular to the radiation incident surface of the reflection plate 4 and that the radiations completely passed through the reflection plate 4 and the compensating member 9. The distance between the focal point 10 of the radiation and the radiation incident surface of the reflection plate 4 was set to 20 mm.

Further, the light source 3 and the restricting blade 2 were disposed so that the radiation field 6 and the visible light field were matched with each other. In this case, the radiation 11a emitted in the direction of the angle θ with respect to the radiation center axis 11 has a relatively long transmission length to pass through the reflection plate 4 and a relatively short transmission length to pass through the compensating member 9. On the contrary, the radiation 11b emitted in the direction of the angle −θ with respect to the radiation center axis 11 has a relatively short transmission length to pass through the reflection plate 4 and a relatively long transmission length to pass through the compensating member 9. In this way, the transmission lengths for the radiations to respectively pass through the reflection plate 4 and the compensating member 9 were able to be compensated for each other.

In this example, the transmission length difference between the radiation passing along the radiation center axis 11 and the radiation 11a or 11b having an angle of 15° with respect to the radiation center axis 11 was able to be a sufficiently small value as) L((1/cos θ)−1)=10((1/cos 15°)−1)=0.4 mm.

The movable diaphragm unit 122 as described above was mounted to the radiation generating unit 101 equipped with the transmission type radiation tube 102 so as to constitute the radiation imaging system illustrated in FIG. 4, and its operation was checked. As a result, it was confirmed that unevenness of the radiation amount and radiation quality was reduced and that an image having reduced gradation was able to be acquired.

Further, because the combined body of the reflection plate 4 and the compensating member 9 had a rectangular parallelepiped shape, the radiation incident surface of the reflection plate 4 and the surface of the movable diaphragm unit 122 on the radiation generating unit 101 side were able to be fixed to each other. Thus, the angle adjustment of the reflection plate 4 necessary for the related-art structure became unnecessary. In addition, because the reflection plate 4 and the compensating member were bonded via the reflection surface 4a, positional adjustment between the members became unnecessary. Because of the above-mentioned two points, the movable diaphragm unit was able to be easily manufactured.

### COMPARATIVE EXAMPLE 1

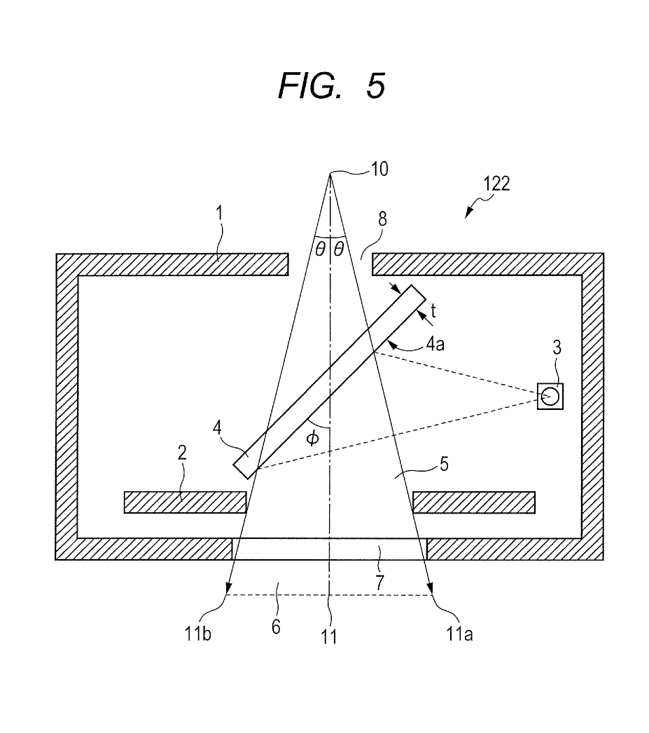

The related-art movable diaphragm unit 122 having a structure illustrated in FIG. 5 was manufactured. A thickness t of the reflection plate 4 was 2 mm, and the reflection plate 4 was disposed at an angle φ=45° with respect to the radiation center axis 11. In this case, the transmission length difference between the radiation 11a and the radiation 11b having an angle of 15° with respect to the radiation center axis 11 was t(1/sin(φ−θ)−1/sin(φ+θ))=2(1/sin(30°)−1/sin(60°)=1.7 mm. Other structures than the above-mentioned structure and layout of the reflection plate 4 were the same as those in Example 1.

The movable diaphragm unit 122 was mounted to the radiation generating unit 101 equipped with the transmission type radiation tube 102 similarly to Example 1 so as to constitute the radiation imaging system of FIG. 4, and its operation was checked. As a result, unevenness of the radiation amount and radiation quality was large because of a large transmission length difference, and the obtained image had a gradation.

### EXAMPLE 2

The movable diaphragm unit 122 having a structure of FIG. 3 was manufactured.

Similarly to Example 1, the combined body of the reflection plate 4 and the compensating member 9 was manufactured, and the convex lens 12 made of glass having spherical and flat surfaces and having a diameter of 30 mm, a radius of curvature of 100 mm, and a center thickness of 3 mm was bonded on the radiation exit side of the compensating member 9. The bonded surface was the flat surface side of the spherical and flat convex lens. Other structures than the convex lens 12 were the same as those in Example 1.

In the movable diaphragm unit 122 of this example, the transmission length difference between the radiation along the radiation center axis 11 and the radiation 11a or 11b having an angle of 15° with respect to the radiation center axis was 0.2 mm, which is further smaller than that in Example 1.

The movable diaphragm unit 122 was mounted to the radiation generating unit 101 equipped with the transmission type radiation tube 102 similarly to Example 1 so as to constitute the radiation imaging system of FIG. 4, and its operation was checked. As a result, it was confirmed that unevenness of the radiation amount and radiation quality was further reduced than Example 1, and that an image having reduced gradation was able to be acquired.

According to the radiation generating apparatus of the present invention, the shading caused by the reflection plate disposed obliquely can be reduced by mounting the compensating member having a thickness variation to the reflection plate or in the vicinity thereof. In addition, because the compensating member hardly affects the structure or the size of the apparatus, the apparatus is not upsized. In addition, the compensating member can be applied to an existing apparatus without adding extensive remodeling. Further, according to the radiation imaging system using the radiation generating apparatus of the present invention, it is possible to perform better imaging with a little influence of the shading.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-042743, filed Mar. 5, 2013, which is hereby incorporated by reference herein in its entirety.

What is claimed is:

1. A radiation generating apparatus comprising:
a radiation generating unit for emitting radiation through a transmission window; and
a movable diaphragm unit including a restricting blade for adjusting a size of a radiation field and a light projecting and collimating device for making simulation display of the radiation field with a visible light field, wherein:
the light projecting and collimating device includes a light source for emitting visible light, and a reflection plate disposed obliquely to a radiation center axis, the reflection plate having a reflection surface for reflecting the visible light and transmitting the radiation;
the visible light field is formed of the visible light which is emitted from the light source and is reflected by the reflection plate; and
the movable diaphragm unit further includes, on a radiation exit side of the reflection plate, a compensating member having a thickness variation for reducing unevenness of the radiation emitted in the radiation field.

2. The radiation generating apparatus according to claim 1, wherein the thickness variation of the compensating member is set so that the compensating member is thicker on a side closer to a focal point of the radiation and is thinner on a side distant from the focal point.

3. The radiation generating apparatus according to claim 1, wherein the compensating member is bonded to the reflection plate via the reflection surface.

4. The radiation generating apparatus according to claim 3, wherein the reflection plate has a thickness variation opposite to the thickness variation of the compensating member, and a total thickness of the reflection plate and the compensating member is constant.

5. The radiation generating apparatus according to claim 4, wherein the reflection plate and the compensating member are both a triangular prism having a cross section of a right triangle and are bonded to each other to form a rectangular parallelepiped.

6. The radiation generating apparatus according to claim 5, wherein the movable diaphragm unit further includes, on the radiation exit side of the compensating member, a convex lens having a largest thickness at a part corresponding to the radiation center axis.

7. The radiation generating apparatus according to claim 1, wherein the radiation generating unit comprises a transmission type radiation tube and a drive circuit for driving and controlling the transmission type radiation tube.

8. A radiation imaging system comprising:
the radiation generating apparatus according to claim 1;
a radiation detecting apparatus for detecting radiation that is emitted from the radiation generating apparatus and passes through an analyte; and
a controlling apparatus for controlling the radiation generating apparatus and the radiation detecting apparatus in a coordinated manner.
